(19) United States
(12) Patent Application Publication
(10) Pub. No.: US 2011/0253069 A1
(43) Pub. Date: Oct. 20, 2011

(54) STATIONARY INTERNAL COMBUSTION ENGINE

(76) Inventors: Thomas GUGGENBERGER, Buch bei Jenbach (AT); Markus Haidn, Maurach (AT); Johann Klausner, St. Jakob i.H. (AT)

(21) Appl. No.: 13/170,476

(22) Filed: Jun. 28, 2011

Related U.S. Application Data
(63) Continuation of application No. PCT/AT2010/000034, filed on Feb. 2, 2010.

(30) Foreign Application Priority Data
Feb. 3, 2009 (AT) A 181/2009

(51) Int. Cl. F02B 63/00

(52) U.S. Cl. 123/2

(57) ABSTRACT

A stationary internal combustion engine comprising a combustion engine and at least one compression device is disclosed. The combustion engine and the at least one compression device are connected to each other without vibrations being transmitted therebetween.

The invention concerns a stationary internal combustion engine comprising a combustion engine and at least one compressor device.

Stationary internal combustion engines are used for example for driving a generator for generating electric current. For that purpose a fuel/air mixture is burnt in combustion chambers of the internal combustion engine. Volumetric expansion of the burnt fuel/air mixture causes movement in a cylinder of a piston, the stroke movement of which is converted into a rotary movement. A generator coupled thereto converts that mechanical energy into electric current. Compressor devices are generally provided to boost power. The compressor devices compress air, that is to say bring it to a higher pressure, before the air is fed into the combustion chamber. In the case of gas engines, that is to say engines in which a gaseous fuel (fuel gas) is burnt, so-called mixture charging is frequently effected. In that way it is not pure air but a fuel/air mixture that is compressed before being passed into the combustion chamber of the combustion engine.

A disadvantage with the state of the art is the fact that compressor devices on stationary internal combustion engines are subject to high wear and consequently have a short service life.

The object of the present invention is therefore that of providing a stationary internal combustion engine of the general kind set forth in the opening part of this specification, in which the above-described problems are alleviated.

In a stationary internal combustion engine of the kind set forth in the opening part of this specification that object is attained by the combustion engine and the compressor device being connected together in vibrationally decoupled relationship.

The compressor device can be connected to the combustion engine for example by way of a separate element which is vibrationally decoupled from the combustion engine and/or the compressor device. For example the vibrational decoupling can be effected by one or more vibration-damping elements. The interposition of a separate element still further reduces the transmission of vibrations from the combustion engine to the compressor device.

Vibrational decoupling which is also referred to as vibration isolation means that the vibrations occurring in the compressor device are not also additionally transmitted to the combustion engine which in any case is already heavily stressed in terms of vibration. Vibrational decoupling means that only a small part of the natural vibration of the combustion engine is transmitted to the compressor device. In the ideal case the maximum amplitude of the vibration is damped by at least 80%, preferably by at least 90%. In that respect for example compensators are considered as the vibrational decoupling device. Typically damping intermediate layers such as for example elastomer intermediate layers and/or resilient intermediate layers and/or compensators are introduced between the combustion engine and the compressor device for vibrational decoupling.

In a preferred variant it is provided that the separate element is made from at least two modules which are releasably fixed together. In that way not only can vibrational decoupling be effected between the combustion engine and the compressor device but it is also possible for individual parts such as for example the compressor device or devices or a cooling device or device to be replaced or modified. In that case vibrational decoupling can be introduced by way of the connecting mechanism between the separate element and the combustion engine.

In a variant it is provided that the sole direct connection between the compressor device and the combustion engine is effected by way of a line which carries the compressed fluid of the compressor device to the combustion engine. Desirably it is provided in that case that a vibration-damping element such as for example a compensator is arranged in that connection.

In a variant it is provided that the at least one compressor device is a rotary compressor. For example it is driven by way of an exhaust gas turbine.

To enhance flexibility it can further be provided that a first module of the separate element is connected to the at least one compressor device and a further module has a cooling device.

To obviate asymmetric loading on the modules it can be provided that the first module is connected to a second rotary compressor wherein the first and the second rotary compressors have a common axis of rotation. Ideally the two rotary compressors are arranged symmetrically on the module, for example by way of a plane of mirror-image symmetry.

In a preferred embodiment the invention also relates to a so-called multi-stage boost. That means that at least two compressor devices are serially connected. In a first compressor, the so-called low-pressure compressor, air or a fuel/air mixture is compressed, then it is generally cooled and finally fed to a second compressor, the so-called high-pressure compressor. In the high-pressure compressor, definitive compression is now effected to the desired pressure which in the case of multi-stage boosts can even be over 6 bars. After a second cooling step which is usually provided the fuel gas/air mixture or the air is now blown into the combustion chamber of the combustion engine. If now a multi-stage boost is provided, it is possible to provide a third module which is connected to the rotary compressor. Preferably that module is separate from the first two modules but can releasably connected to them.

In the case of large engines with for example two banks of cylinders in a V-arrangement it can be provided that each bank of cylinders has its own associated compressor device or its own associated exhaust gas turbine. If now two rotary compressors are connected in series, it has proven desirable in a particularly preferred variant if a line parallel to the axis of rotation of the rotary compressor connected to the third module is arranged substantially at a right angle to the axis of rotation of the at least one rotary compressor connected to the first module. Ideally it is provided in that case that the third module is connected to a further rotary compressor, the axis of rotation of which is arranged substantially parallel to the axis of rotation of the first rotary compressor connected to the third module.

In a variant it can be provided that the first compressor device on the first module and the first compressor device on the third module as well as the second compressor device on the first module and the second compressor device on the third module are respectively connected in series.

In a further variant it can be provided that there is a further cooling device, preferably on a separate module.

In an aspect the invention concerns an element of the aforementioned kind for an internal combustion engine.

Further advantages and details of the invention will be described by means of the following Figures and the specific description.

In the Figures:

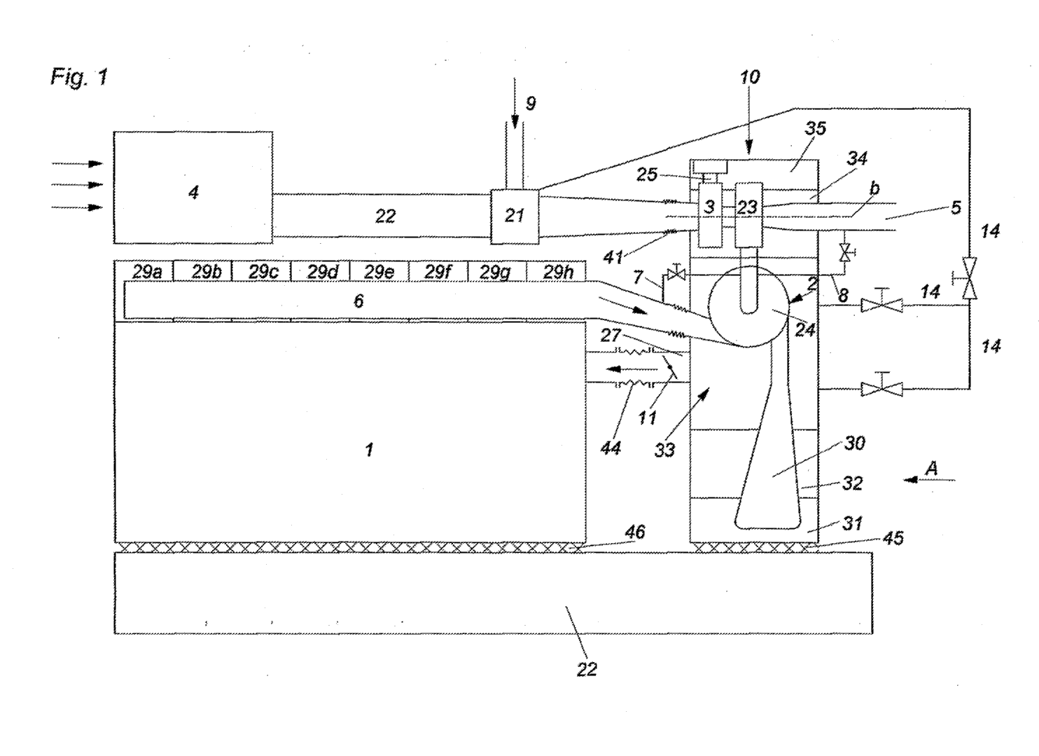

FIG. 1 shows a diagrammatic side view as an overview of a stationary internal combustion engine according to the invention,

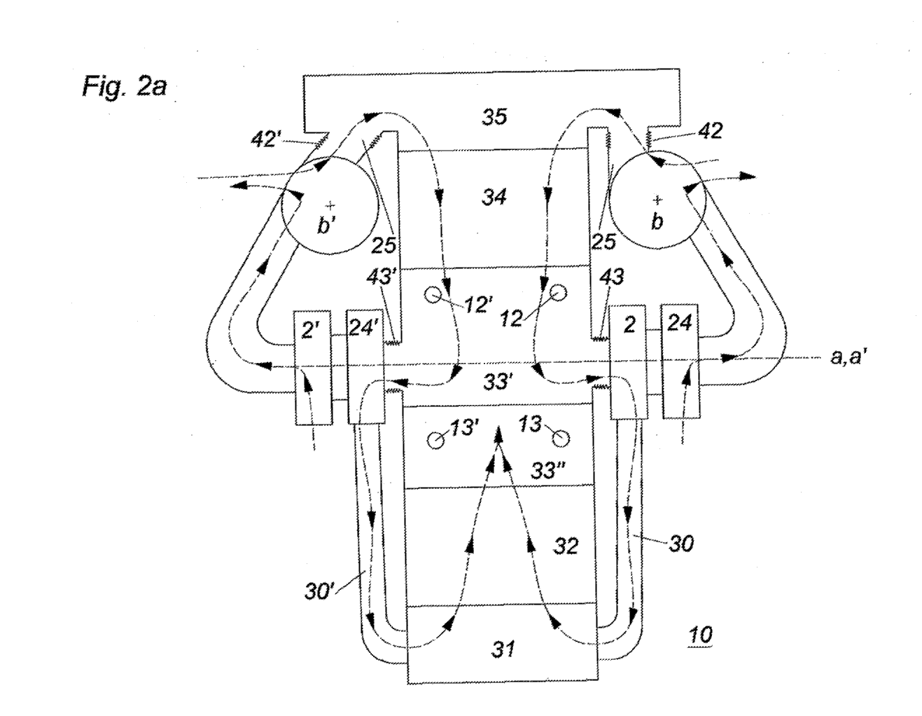

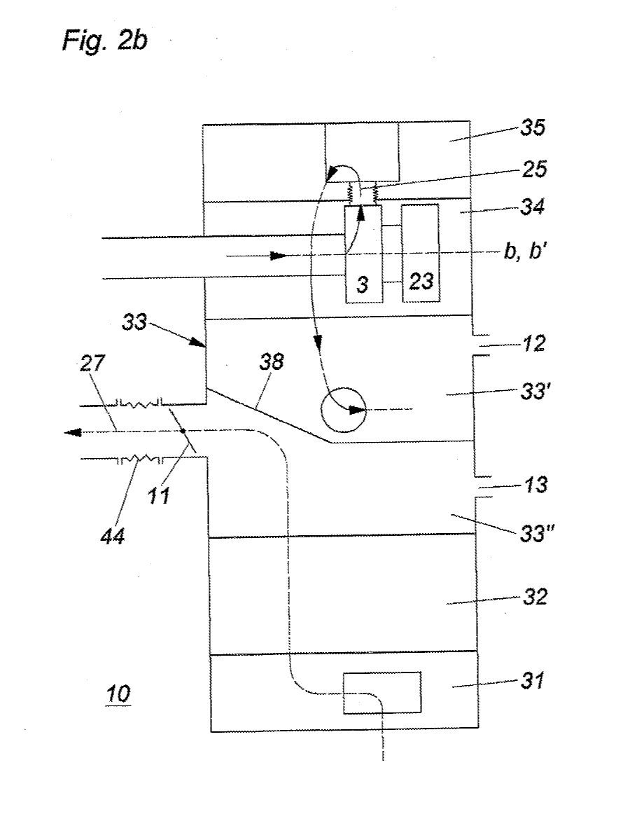

FIGS. 2a and 2b show two diagrammatic views of a separate element according to the invention, and

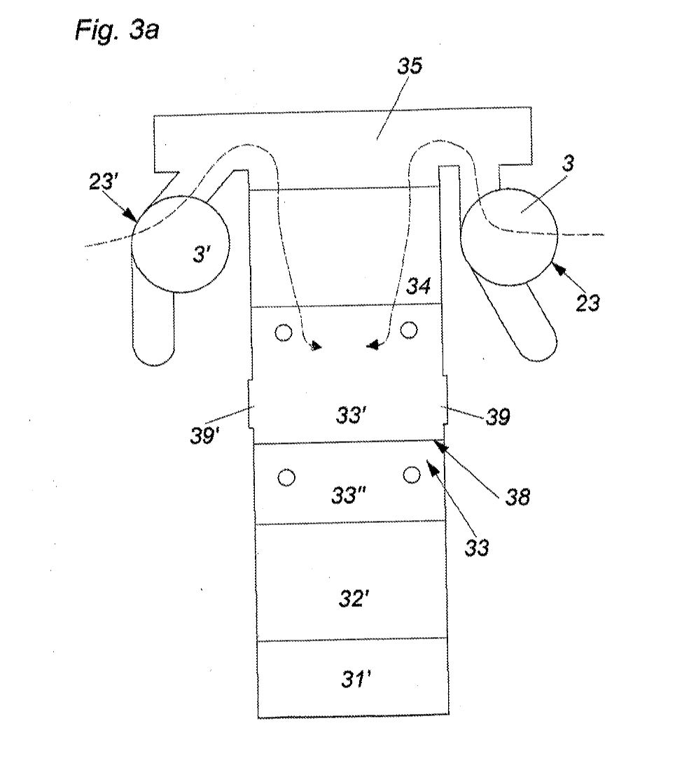

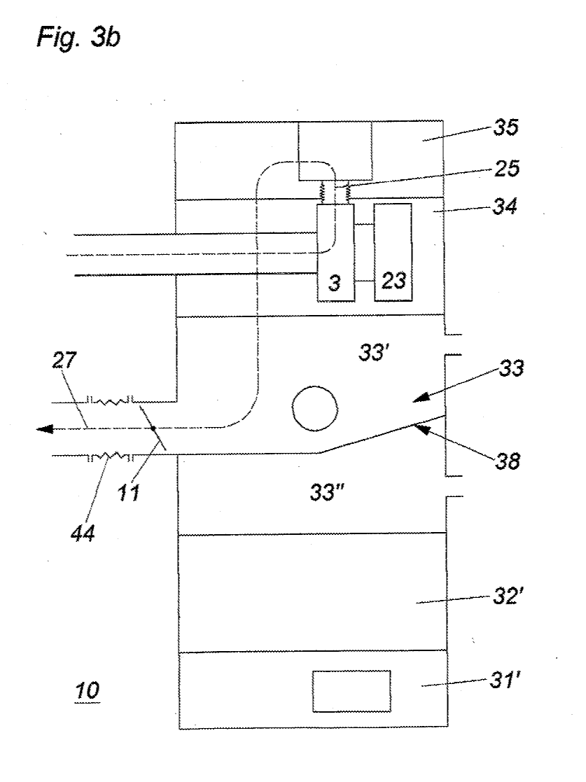

FIGS. 3a and 3b show a modified variant in accordance with FIGS. 2a and 2b.

FIG. 1 diagrammatically shows a side view of an internal combustion engine according to the invention. It has a combustion engine 1 with two banks of cylinders in a V-arrangement, in which case it is possible to see the front eight cylinders 29a through 29h. In addition there are a total of four compressor devices 2, 2′, 3, 3′, wherein a first compressor device 2 (concealed by the exhaust gas turbine 23) and a second compressor device 3 which are connected in series can be seen. The two compressor devices 2′, 3′ which are also connected in series with each other (but parallel with the compressor devices 2, 3) are concealed and are only shown in subsequent FIGS. 2a and 2b.

In operation air is drawn in by way of an air filter 4 (arrows) and passed by way of tubes 22 to a gas mixer 21. In the gas mixer 21 fuel gas supplied by way of a fuel gas feed conduit 9 is mixed with the air and passed on to the compressor devices 3, 3′ which are vibrationally decoupled in relation to the combustion engine 1. Compensators 41, 41′ are provided for that purpose. From the compressor devices 3, 3′ the mixture which is now compressed passes by way of the conduits 25, 25′ in which compensators 42, 42′ (see FIGS. 2a and 2b) for vibrational decoupling are also provided, to the separate element 10. In the illustrated embodiment the separate element 10 is of a modular structure and includes the modules 31 through 35 which hereinafter are also described in greater detail with reference to FIGS. 2a and 2b. The first module (deflection module) 35 is connected to two compressor devices 3, 3′ in vibrationally decoupled relationship, those compressor devices 3, 3′ having parallel axes of rotation b, b′. The fuel gas/air mixture is compressed for the first time in the first compressor devices 3, 3′ (low-pressure compressors). The mixture which has now been pre-compressed is then passed by way of the conduit 25 into the interior of the module 35 and deflected there. From the first module 35 the gas mixture is fed to the second module 34 disposed therebeneath, which has a cooling device. The mixture flows through the second module 34 to the central module 33 from where it flows laterally into the compressor devices 2, 2′, the so-called high-pressure compressors (the two high-pressure compressors 2, 2′ are also vibrationally decoupled from the separate module 10 by way of compensators 43, 43′). There the mixture is compressed to the final pressure. The compressed gas mixture flows by way of the conduits 30, 30′ to the deflection module 31 in which the gas flow is again deflected. The next station is the module 32 having a further mixture cooler for cooling the mixture. From the module 32 the mixture is now passed into the central module 33 from where it is actually fed to the combustion engine 1 by way of the conduit 27. For example a throttle device 11 such as a throttle flap can be provided in the conduit 27 to be able to provide for quantitative regulation of the amount of gas flowing therethrough. The mixture now further flows to the cylinders 29 where combustion takes place. At that location it is also possible to particularly clearly see the compensator 44 which provides for vibrational decoupling between the combustion engine 1 and the separate element 10. The combustion engine 1 and optionally the element 10 are arranged on a damper rubber 45, 46.

After combustion the burnt gas mixture is passed into the exhaust gas manifold tract 6 from where the exhaust gas is passed to the turbines 24, 24′ driving the compressor devices 2, 2′. The exhaust gas is further passed by way of the conduit 30 to the second exhaust gas turbines 23, 23′ which in turn drive the compressor devices 3, 3′. Finally the exhaust gas is expelled by way of an exhaust gas discharge system 5. It is also possible to see the conduits 7, 7′ and 8, 8′ which are bypass conduits. Exhaust gas can be taken past the exhaust gas turbines 24, 24′ by means of the bypass conduits 7, 7′ and also past the exhaust gas turbines 23, 23′ by means of the bypass conduits 8, 8′.

The modular structure of the separate element 10 will now be described separately once again with reference to FIGS. 2a and 2b. FIGS. 2a and 2b show diagrammatic views of the modules 31-35 of the separate element 10 in FIG. 1. In this respect FIG. 2a shows a view along the direction of view A and FIG. 2b shows a view along the direction of view shown in FIG. 1. The element 10 is made up of the modules 31 through 35 which are releasably fixed together. The individual modules can be fixed together for example by way of screw connections (not shown). The central module 33 is connected to two high-pressure compressor devices 2, 2′, the axes of rotation a, a′ of which coincide. A line parallel to the axes of rotation a, a′ is arranged perpendicularly to the axes of rotation b, b′ of the compressor devices 3, 3′. The high-pressure compressors 2, 2′ are driven by exhaust gas turbines 24, 24′. Arranged above the module 33 is a module 34 carrying a cooling device. Arranged thereabove is a further module 35 on which two further compressor devices 3, 3′ are arranged. These are the low-pressure compressors which are also driven by compressor devices 23, 23′. Uncompressed fuel/air mixture now flows into the compressor devices 3, 3′ and is compressed in the low-pressure compressor. From there the mixture flows through the module 35 to the first mixture cooler arranged in the module 34. From there it flows further into the central element 33 where it is deflected by the inclinedly arranged baffle wall 38 to the respective high-pressure compressors 2, 2′. From there the gas which is now highly compressed flows by way of the deflection module 31 to the module 32 in which a further cooler is disposed. The mixture is deflected again by way of the baffle wall 38 to the throttle device 11 which is also carried on the central module 33 (see FIG. 2b). The exhaust gas flow from the exhaust gas manifold to the exhaust gas discharge system 5 is shown with a broken line.

FIG. 2b now shows the side view. Here too it is possible to see the flow of gas from the uncompressed fuel/air mixture by way of the low-pressure compressor 3 to the module 35 and from there to the module 34 with mixture cooler. From there the gas mixture flows to the central module 33 where the mixture is deflected. The gas mixture flows perpendicularly to the plane of the illustration out of that plane and into that plane respectively, into the respective high-pressure compressor 2, 2′. From there it is diverted by way of the conduits 30, 30′ which are not shown for the sake of enhanced clarity of the drawing to the module 31 where it is possible to see an opening. From there the mixture flows through the module 32 with mixture cooler and back into the central module 33 where deflection takes place. Finally the mixture flows in the direction of the combustion engine 1, wherein there is also provided a throttle flap 11.

The central module 33 has a plurality of functions. On the one hand it is connected to the two compressor devices 2, 2′. In addition it has two chambers 33′, 33″ which are separated by the baffle wall 38, wherein the gas which has undergone low compression flows through the first chamber 33′ and the highly compressed gas flows through the second chamber 33″. At the same time the gas is deflected on the one hand to the compressors 2, 2′ and on the other hand to the combustion engine 1. Finally it carries the throttle device 11. The illustrated connections 12, 12′, 13, 13′ represent bypass options corresponding to the conduits 14, 14′ in FIG. 1.

The module 31 is carried on the base 22 of the internal combustion engine and is fixed there in vibrationally decoupled relationship by damping layers. Here too there is a releasable fixing. If necessary the modules 31-35 can be individually exchanged. The combustion engine 1 is also carried on the base 22. A damping layer 46 decouples vibration in relation to element 10.

The arrangement of the individual components can be seen only in the front plane of the drawing. In itself the internal combustion engine however is of a symmetrical structure so that respective compressor devices 2′ and 3′ and cylinders 29′ are also arranged in the background. In this example the axes of rotation a, a′ of the compressor devices 2′, 2 coincide. The axes of rotation b, b′ of the compressor devices 3, 3′ are substantially parallel. In addition lines parallel to the axes of rotation b, b′ of the compressor devices 3, 3′ are perpendicular to the axis of rotation a, a′ of the compressor devices 2, 2′. That perpendicular arrangement means that the tubing (conduits 39, 39′) can be particularly short.

The separate element 10 provided according to the invention is vibrationally decoupled from the combustion engine 1. The combustion engine 1 and the separate element 10 are arranged on a base 22. The separate element 10 can now be mounted on the base portion 22 in vibrationally decoupled relationship from the combustion engine by way of a compensator or damping materials such as elastomeric intermediate layers or spring elements (this is not shown).

FIGS. 3a and 3b show a variant of the example of FIGS. 1 through 2b so that the same components as in FIGS. 1, 2a and 2b are denoted by the same references. The essential difference in relation to the preceding example is that there is no second compressor device 2, 2′. Sole compression is effected by way of the first compressor devices 3 and 3′ respectively. The central module 33 is modified in comparison with FIGS. 2a and 2b in that the baffle wall between the two chambers is displaced so that deflection is into the other direction and the conduit 27 is supplied directly with the mixture. For example the elements 31, 32 can be replaced by a simple base or foot portion or dummy modules 31′, 32′. It is possible to change over to simple compression by simple modified tubing from the exhaust gas manifold 6 to the exhaust gas turbines 24, 24′ (see FIGS. 3a and 3b).

1. A stationary internal combustion engine including a combustion engine and at least one compressor device, wherein the combustion engine and the at least one compressor device are connected together in vibrationally decoupled relationship by vibration decouplers in the form of compensators and/or damping intermediate layers and/or resilient intermediate layers.

2. An internal combustion engine as set forth in claim 1, wherein the compressor device is connected to the combustion engine by way of a separate element which is vibrationally decoupled from the combustion engine and/or the compressor device.

3. An internal combustion engine as set forth in claim 2, wherein the separate element is made up from at least two modules which are releasably fixed together.

4. An internal combustion engine as set forth in claim 1 wherein the at least one compressor device is a rotary compressor.

5. An internal combustion engine as set forth in claim 2, wherein a first module has the at least one compressor device and a second module has a cooling device.

6. An internal combustion engine as set forth in claim 5, wherein the first module has a second rotary compressor, wherein the first and second rotary compressors have a common axis of rotation.

7. An internal combustion engine as set forth in claim 3, wherein a third module has a rotary compressor.

8. An internal combustion engine as set forth in claim 7, wherein the axis of rotation of the rotary compressor of the third module is arranged in skew relationship with the axis of rotation of the at least rotary compressor on the first module.

9. An internal combustion engine as set forth in claim 7, wherein a line parallel to the axis of rotation of the rotary compressor of the third module is arranged substantially at a right angle to the axis of rotation of the at least one rotary compressor on the first module.

10. An internal combustion engine as set forth in claim 8, wherein the third module has a further rotary compressor whose axis of rotation is arranged substantially parallel to the axis of rotation of the first rotary compressor on the third module.

11. An internal combustion engine as set forth in claim 10, wherein the first compressor device on the third module and the first compressor device on the first module as well as the second compressor device on the first module and the second compressor device on the third module are respectively connected in series.

12. An internal combustion engine as set forth in claim 5, wherein there is provided a further cooling device, preferably on a separate module.

13. An element as set forth in claim 2 for a stationary internal combustion engine.
